(19) United States
(12) Patent Application Publication
(10) Pub. No.: US 2006/0188096 A1
(43) Pub. Date: Aug. 24, 2006

(54) Systems and methods for remotely controlling computer applications

(76) Inventor: Joseph Gerard Aguilar, Oak Lawn, IL (US)

Correspondence Address: JONES DAY, 222 EAST 41ST ST, NEW YORK, NY, 10017, US

(21) Appl. No.: 11/205,239

(22) Filed: Aug. 15, 2005

Related U.S. Application Data
(63) Continuation-in-part of application No. 11/068,612, filed on Feb. 28, 2005, now abandoned.
(60) Provisional application No. 60/548,726, filed on Feb. 27, 2004.
(60) Provisional application No. 60/601,244, filed on Aug. 13, 2004.

(51) Int. Cl. H04N 7/167

(52) U.S. Cl. 380/200

(57) ABSTRACT

A modular system and method is for displaying and controlling a host computer application interface using a real-time video and control stream to a remote digital media receiver client is disclosed. The continuous graphical display pixels and audio of a host computer application interface window are divided into time segments of a predetermined length. These segments are then subsequently coded as video and audio streams. These video and audio streams are then sent to a remote digital media receiver client where they are decoded for display on a television device or played back on an audio system. the host computer application interface is controlled by user commands that originate at the remote digital media receiver client. The commands are sent over a control channel that is established between the host computer and the digital media receiver.

This application is a continuation in part of a utility application Ser. No. 11/068,612, filed on Feb. 28, 2005, incorporated herein by reference, that claims priority of provisional application Ser. No. 60/548,726, filed on Feb. 27, 2004, and this application also claims priority of provisional application Ser. No. 60/601,244 filed on Aug. 13, 2004.

### FIELD OF THE INVENTION

The present invention relates to computer networks, and more particularly to content streaming.

### BACKGROUND OF THE INVENTION

Currently, there is a perceived need for devices capable of both remotely controlling the execution of a computer application running on a remote host and presenting the application output. Such devices should be robust and should be able to decode encrypted data sent from the remote host. An example includes remotely controlling a media player and viewing its output.

This application provides a methods and systems where the processing power required for running a computer application is separated from devices that control the execution of the application remotely. This allows such devices to be simple and inexpensive.

### SUMMARY OF THE INVENTION

In a preferred embodiment, the system and method disclosed herein enable a Digital Media Receiver (DMR) device to run, control and view arbitrary computer operating systems and applications (i.e., Microsoft Windows, Apple MacOS, Microsoft Word, Microsoft Internet Explorer, PC Video Games, Microsoft Media Player, Real Networks Media Player, etc.) that are hosted on remote computers. The disclosed systems and methods provide for concurrent delivery and control of a host computer application via an audio and video stream and a network control channel. The real-time audio and video streams are referred to as Application Interface Media Stream (AIMS). The AIMS is sent from the host computer to DMR over a computer network. The DMR then receives AIMS, decodes it, and renders it for display on a TV device. The Host Computer application is controlled through the use of user controlled DMR control devices. Commands issued by the DMR control devices are sent to a Host Computer Application over a computer network, which in turn enables the update and control of the application GUI and video screen events and audio application interface output in response to these commands.

In another aspect, the system and methods of this application also enable the DMR device to run, control and view a media player application hosted on a remote computer which is different from other applications in two ways: (1) the remote computer must have components for converting of media formats which the DMR is unable to decode to those that the DMR is able to decode, and (2) the media player application provides context switching so that the video of a file selected by the user completely replaces the GUI which facilitates the file selection on the TV display

The general operation of the preferred embodiment is a follows: first, a session is established between the DMR and the Host Computer; then concurrently the audio and video on the Host Computer is encoded in the time slices streams which are sent to the DMR and the DMR receives control messages from the user, which are encoded and sent to the Host Computer, where they are decoded and used to manipulate the execution of the application.

In particular, in one aspect, a method for controlling computer applications remotely is disclosed that comprises the steps of running a computer application on a host computer; establishing an electronic data communication between the host computer and a remote receiver over a media channel and an application control channel; sending application output from the host computer to the remote receiver over the media channel; presenting the application output at the remote receiver; and receiving at the host computer of a command related to the presented output from the remote receiver over the application control channel is disclosed.

Also described is a receiver for presentation and control of computer applications running on a remote host computer, comprising: data handling means for establishing one or more communication channels between the receiver and the remote host; data processing means for decoding application output data received from the remote host; data control means for encoding control signals from the receiver to the remote host; and input means for entering control commands by a user of the receiver is disclosed.

### BRIEF DESCRIPTION OF THE DRAWINGS

Embodiments described in this application may be understood more fully by reference to the following detailed description of the preferred embodiments, and the appended figures in which:

FIG. 1 is a block diagram of a system for controlling, displaying, transmitting and receiving a Host Computer's Application Interface through a plurality of control and media streams over a computer network;

FIG. 2 is a block diagram of a system for controlling, displaying, transmitting and receiving a Host Computer's Media Player Application Interface as well as it's A/V media archive through a plurality of control and video streams over a computer network.

### DETAILED DESCRIPTION OF THE EMBODIMENTS

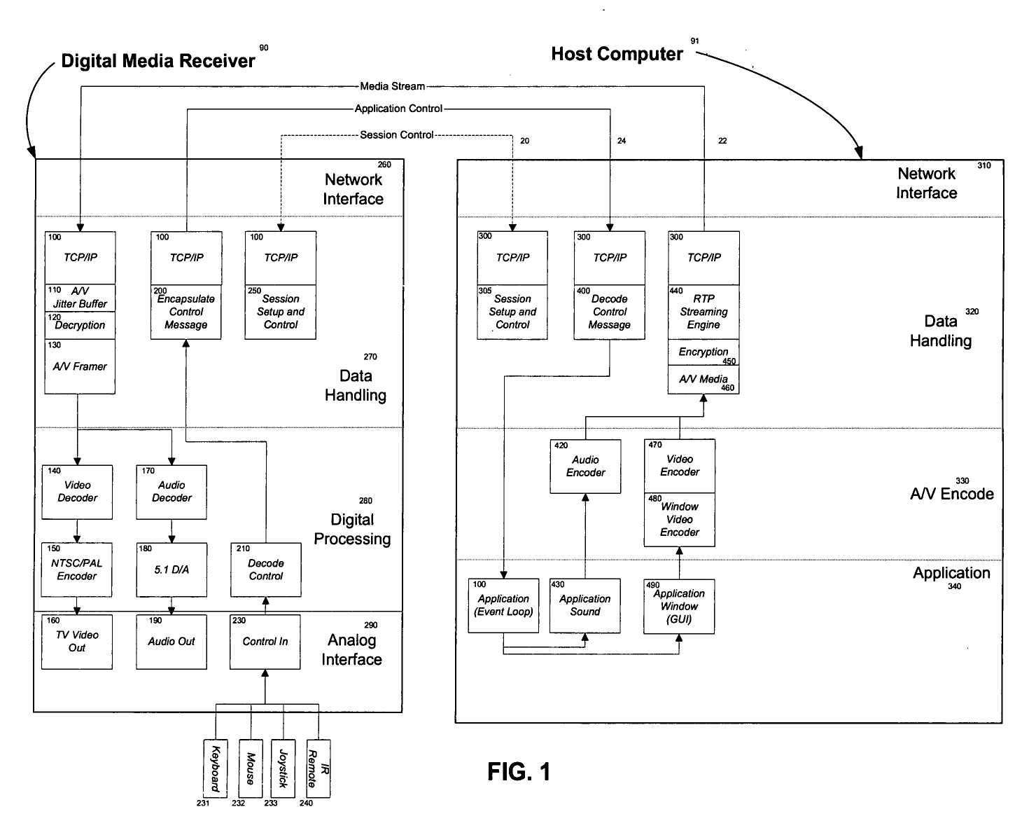

In the first embodiment of the invention schematically illustrated in FIG. 1, there is a Digital Media Receiver (DMR) 90 (which could be a network enabled DVD player, a personal computer running software specialized to support the DMR functions, etc.) with its network interface 260 connected to the network interface 310 of the Host Computer 91. The network interfaces 260 and 310 may be “wired” (i.e. IEEE 802.3 Ethernet) or wireless (i.e. IEEE 802.11) hardware devices that use Transmission Control Protocol/Internet Protocol (TCP/IP) stack 100 and 300, respectively. The stack may be provided as a software communications service and should at least provide standard TCP/IP and UDP/IP packet switched data communication channels between the DMR and any TCP/IP based device on the network, such as the Host Computer 91. The network interfaces could also be USB, IEEE 1394, etc.

Session Setup and Control components are used to establish communication session between the DMR 90 and the Host Computer 91. Session Setup and Control components on the DMR 250 may use Universal Plug and Play (UPnP) as outlined by UPnP Forum. For the DMR the Session Setup and Control component 250 essentially provides:

1. An IP address for the DMR, using either static or Dynamic Host Control Protocol (DHCP) based assignment;

2. A method for discovering and connecting a compliant Host Computers on the network to DMR.

3. A method for negotiating, establishing and tearing down session based TCP/IP based socket connections between the DMR and the compliant Host Computers on the network. These socket connections are both TCP/IP and UDP/IP based communication channels. These socket connections carry Real-Time Video, Audio, and control messages between the DMR and the Host Computer.

4. When applicable it also negotiates encryption decryption keys for secure communication channels as well as Digital Rights Management (DRM) schemes. It then forwards the decryption keys to the Decryption component 120 of the DMR 90. It should be noted that in the preferred embodiment a proprietary low complexity DRM scheme is intended to be run between the DMR and the Host Computer known as Light Weight DRM and that high complexity industry standard based DRM platforms will be terminated on the Host Computer. Alternatively an industry standard such as Digital Transmission Content Protocol (DTCP) can be used between the DMR 90 and Host Computer 91 to protect the media from illegal copying.

For the Host Computer 91, the Session Setup and Control component 305 essentially provides:

1. A method for discovering and connecting the DMR devices on the network.

2. A method for negotiating, establishing and tearing down session based TCP/IP based socket connections between the Host computer and DMR's on the network. These socket connections are both TCP/IP and UDP/IP based communication channels. These socket connections carry Real-Time Video, Audio, and control messages between the DMR and the Host Computer.

3. When applicable it also negotiates Encryption/Decryption Keys for secure communication channels as well as Digital Rights Management (DRM) platforms. It then forwards the decryption keys to the Encryption component 450 of the Host Computer 91.

This exchange occurs over a session control channel 20. Once the session between the DMR and the Host Computer is established, the media streams may be sent from the Host Computer 91 to the DMR 90 over Media Stream Channel 22, and the control messages may be sent from the DMR 90 to the Host Computer 91 over Application Control Channel 24.

Application (Event Loop) 410 which runs on the Host Computer handles and processes all control events. It has direct access to all application sub-systems as well as the GUI interface. Application Sound component 430 generates audio specific to the application such as operating system sound beeps, or audio indicators that are generated as a GUI auditory aid. The Audio Encoder 420 compresses the audio streams using compression codecs that are compatible with those used on the DMR device. Application Window (GUI) 490 is an actual window or set of windows and dialog boxes that make up the user interface of the application. The Window Video Encoder 480 generates a raw video stream by sampling the video buffer within the region of memory occupied by the application's GUI window on the Host Computer 91. The resolution and scan structure of the video is then resampled to an optimal display format supported and previously negotiated by the DMR during the Session Setup. Typical video resolution formats are as follows: interlaced or progressive 720×480 pixels for standard definition NTCS-TV or 720p, 1080i, 1080p HDTV. The raw video frame rate is then resampled to an optimal display rate supported by the DMR hardware. The raw video is then passed on the Video Encoder 470 which compresses the video streams using compressing codecs that are compatible with those used on the DMR device. The two compressed streams, audio and video, are then sent to the Audio/Video (A/V) Media component 460, which maintains the information regarding system time synchronization between the audio and video streams resulting from the application 410. The A/V Media component 460 also constructs the Audio/Video stream formats used during the Real-time Transfer Protocol (RTP) sessions. Then the Audio/Video media packets are encrypted by the Encryption component 450 using the encryption key negotiated during the session setup process by the Session Setup and Control component 305.

RTP Streaming Engine 440 packetizes A/V data using RTP and forwards the packets to the DMR via the IP network over the Network Interface 310, where appropriate headers are appended to the packets by TCP/IP stack 300 over Media Stream Channel 22. It should be noted that RTP can be replaced with Hyper Text Transfer Protocol (HTTP), or any packetized streaming media format.

The DMR receives the media streams on its Network Interface 260 and processes the packets extracting the payload by its TCP/IP stack 100. The A/V Jitter Buffer 110 manages the receipt, synchronization and sequencing of all real-time media packets that are sent to the DMR. It separates the packets into stream type (audio and video) and then manages the optimum Jitter Buffer length based on the joint inter-arrival time of each media stream. The Decryption component 120 decrypts all the encrypted media packets that are sent to the DMR with the decryption key which was provided to it during session setup by the Session Setup and Control component 250. A/V Framer 130 separates the decrypted audio and video packets from the A/V Jitter Buffer 110 and encapsulates them into hardware dependent media stream formats. The video stream is then forwarded to the Video Decoder 140 which takes video frames from the A/V Framer 130 and decodes them into a raw video stream. The raw video stream is then forwarded to the NTSC/PAL Encoder 150, which converts it either to NTSC or PAL format depending on the country of operation specified. The analog NTSC/PAL signal is then forwarded to the TV Video Out component 160 which takes the analog video signal from the NTSC/PAL Encoder 150, power amplifies the signal and sends it to a standard TV out interface such as composite, interlaced component, or progressive component.

The audio stream is forwarded to the Audio Decoder 170 which takes the compressed audio signal channels(s) from the A/V Framer 130 and decompresses them into linear pcm channel(s). The linear pcm channel(s) are then forwarded to the 5.1 D/A converter 180 which converts the linear pcm audio signal channel(s) from the Audio Decoder component 170 to analog audio signal channels. The Audio Out 190 component provides both an analog and digital interface mode of operation. The analog mode of operation takes the low level audio analog signal from the 5.1 D/A converter 180 and provides power amplification on the audio signal before sending it over a standard multi-channel Radio Corporation of America (RCA) audio out interface. The digital mode of operation takes the raw digital channels from the 5.1 D/A converter 180 and outputs them over optical or electrical Sony/Philips Digital Interface Format (S/PDIF).

As audio and video information is transferred to DMR 90 from the Host Computer 91 the user at the DMR 90 may control the execution of the application on the Host Computer 91. The Control In component 230 is a physical interface by which any controlling devices (i.e. keyboard 231, Mouse 232, joystick 233, infrared (IR) remote control device 240) communicates with the DMR 90. The controlling devices are used by the user to manipulate and navigate through the application interface displayed by the DMR as well as to control and manipulate the playback of arbitrary stream of media (i.e., video, audio, photos) through the DMR.

The Decode Control component 210 decodes the electrical control messages received from the controlling devices 231, 232, 233, and 240 by the Control In component 230 into a data control code. For example, when a button is depressed on the IR remote 240, an electrical signal is generated within the Control In component 230. This electrical signal corresponds to a physical button that was depressed on the IR remote 240. The Decode Control component 210 then maps this signal into the data control code which corresponds to the physical button that was depressed. The decoded control message is then encapsulated by the Encapsulation component 200. Any control protocol can be used in this component. Typical examples are Real Time Streaming Protocol (RTSP), and HTTP. The encapsulated message is then sent over the Network Interface 260 via TCP/IP Application Control Channel 24 to the Host Computer 91. The Host Computer 91 receives the packets on its Network Interface 310 and processes them by the TCP/IP stack 300. It then passes the payloads of these packets to the Decoder 400 which decodes the control messages from the DMRs and forwards them to the appropriate application on the Host Computer. It should be noted that the control protocol used here can also be translated to other control protocols in order to support arbitrary applications. For example the proprietary low memory/complexity protocol can be translated to RTSP or HTTP so that it may support Digital Home Working Group (DHWG) compliant hosting applications. The Decoder 400 then forwards the control messages to the Application (Event Loop) 410, which handles and processes all control events.

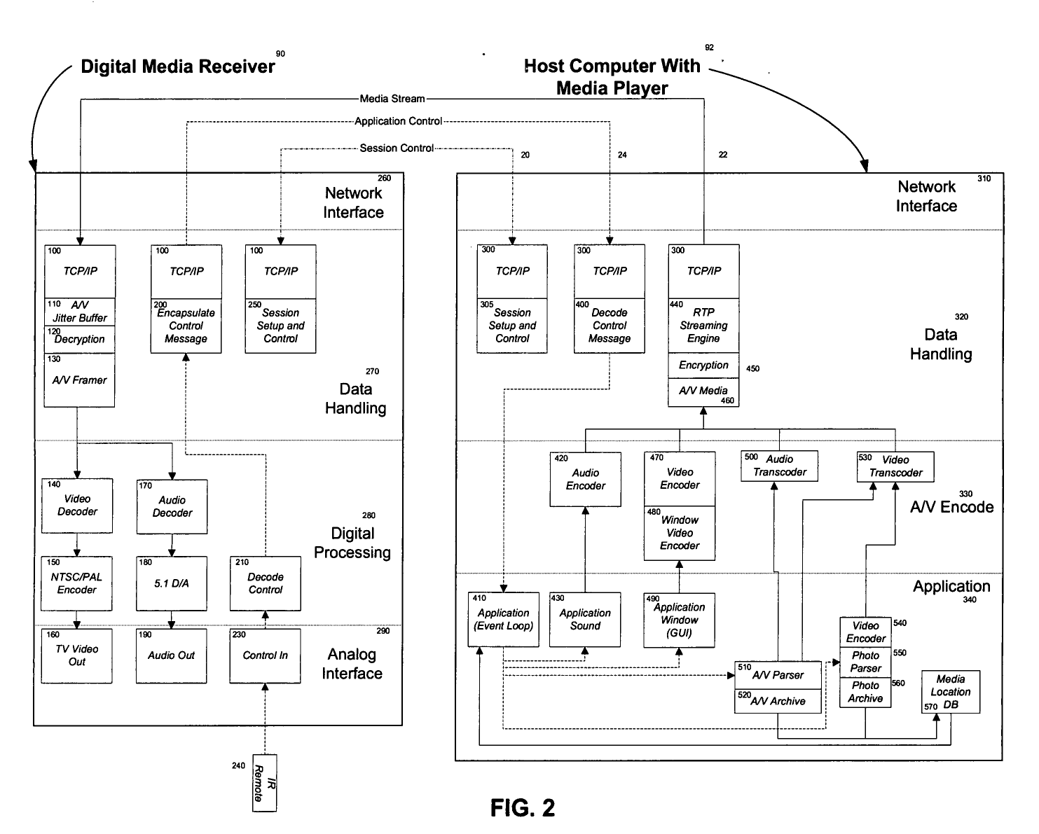

The second embodiment of the invention is schematically illustrated in FIG. 2, where the Host Computer with Media Player 92 is utilized. In this embodiment, the Host Computer 92 has several additional components compared to the Host Computer 91 of the first embodiment. Specifically, the Host Computer with Media Player 92 contains a Media Location Database (DB) 570 which contains information regarding the type, format, name and computer addressable location of every audio, video, and photo file available for computer access. The Media Location DB 570 interfaces with A/V Archive 520 that is the location where the audio and video files are physically stored for computer retrieval and Photo Archive 560 that is the location where the photo files are physically stored for computer retrieval. A/V Archive 520 and Photo Archive 560 can be local to the Host Computer 92 or stored on the network (IP, IEEE 1394, USB, etc.) device attached to the Host Computer 92. The Media Location DB 570 communicates with the Application 410, so the content of the database may be transferred to the DMR 90. Once the user at the DMR selects a file which he wants to retrieve, and this information is propagated to the Application 410 from the DMR 90, two situation are possible: the file is an audio or video file, or a static photograph. If an audio or video file is requested by the user at the DMR 90, the Application 410 will access the A/V Parser 530 which converts audio and video files into seekable packetized media streams. The A/V Parser 510 supports common media control commands such as play, pause, stop, fast forward, rewind, and seekable rate with and without time scale modification, etc. These commands are supported through primitive file seek and read commands. Once the A/V Parser 510 locates the index within the file that corresponds to the absolute time requested by the DMR it proceeds to send frames of audio or time synchronized frames of audio and video to the respective transcoder components along with an absolute real-time stamp of each packet of media. The absolute real-time stamp is used to identify fast forward and rewind commands that require the media to be resampled in time by subsequent processing components within the system.

The Audio Transcoder 500 is used to reformat audio channels which are not stored in formats supported by the DMR 90. This is achieved by first decompressing the audio channels into raw audio and then recompressing it with a compression format supported by the DMR 90. The DMR supported audio compression formats are negotiated during session setup. If the absolute real-time stamp and sampling frequency are different than the original sampling frequency time scale modification is performed over the audio packets. The time scale modification can either be continuous (with or without pitch scale modification) or discrete depending on the user's preference.

The Video Transcoder 530 is used to reformat video channels which are not stored in formats supported by the DMR 90. This is achieved by first decompressing the video channels into raw video and then recompressing them with a compression format supported by the DMR 90. The DMR supported video compression formats are negotiated during session setup. If the absolute real-time stamp and sampling frequency are different than the original sampling frequency time scale modification is performed over the video packets. The time scale modification can either be continuous or discrete depending on the users preference. When the selected file is an audio file, there is not video channel and the Video Transcoder 530 is not used.

When a user selects a digital photographs for retrieval, the Photo Parser 550 converts the photographs into a raw video stream. It performs this by first decompressing the photograph into a raw still image frame. The still image frame is then resampled to a video resolution and scan structure supported and previously negotiated by the DMR device 90 during session setup. Typical video resolution formats are as follows: interlaced or progressive 720×480 pixels for standard definition NTCS-TV or 720p, 1080i, 1080p HDTV. The video frame is then repeated at a frame rate supported by the DMR hardware. For example, based on the knowledge that the DMR supports NTSC devices, the optimal NTSC frame rate will be selected. The raw video is then passed on to the Video Encoder 540, which is similar to Video Encoder 470, and then to Video Transcoder 530.

The outputs of Audio Transcoder 500 and Video Transcoder 530 are then passed to A/V Media component 460, and then processed and sent to the DMR 90 according to the method described for the first embodiment. When the user at the DMR 90 requests a media file from the Host Computer 92, the context is switched. In other words, the video completely replaces the GUI seen by the user. The playback of the selected file may be interrupted by the user's request and the context can be switched back at any point.

The invention described and claimed herein is not to be limited in scope by the exemplary embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

We claim:

1. A method for controlling computer applications remotely, comprising the steps of:
running a computer application on a host computer;
establishing an electronic data communication between the host computer and a remote receiver over (1) media channel and (2) an application control channel;
sending application output from the host computer to the remote receiver over the media channel;
presenting the application output at the remote receiver; and
receiving at the host computer of a command related to the presented output from the remote receiver over the application control channel.

2. The method of claim 1 further comprising the step of modifying the presentation of the application output at the remote receiver in response to the received command.

3. The method of claim 1, wherein the application output comprises user interface and sounds.

4. The method of claim 1, wherein the step of establishing electronic data communication comprises:
obtaining a network address for the remote receiver; and
negotiating parameters associated with the media channel and the application control channel.

5. The method of claim 1, wherein establishing the electronic data communication is in accordance with the Universal Plug and Play standard.

6. The method of claim 4 wherein the host computer and the remote receiver are connected by IP computer network.

7. The method of claim 6 wherein the step of negotiating comprises exchanging encryption and decryption keys between the remote receiver and the host computer.

8. The method of claim 7 further comprising:
encrypting the output of the application on the host computer; and
decrypting the output of the application on the remote receiver.

9. The method of claim 6 wherein the step of sending further comprises:
encoding the user interface into a video format which the remote receiver is capable of decoding;
encoding the sounds into an audio format which the remote receiver is capable of decoding;
combining the encoded video and the encoded audio into an audio/video stream;
formatting the audio/video stream into date packets.

10. The method of claim 6 wherein the step of presenting further comprises:
sending the packets to the remote receiver;
reconstructing the audio/video stream from the packets on the remote receiver;
separating the encoded audio and the encoded video;
decoding the video of the graphical user interface;
sending the video of the graphical user interface to a video output device;
decoding the audio of the application sounds; and
sending the audio of the application sounds to an audio output device.

11. The method of claim 6 wherein the application executed by the host computer is a media player, and the method further comprises the steps of:
displaying at the remote receiver a user interface for browsing through one or more media files accessible by the host computer;
receiving at the host computer a selection of one or more media files, the selection being made at the remote receiver; and
sending the selected one or more media files from the host computer to the remote receiver.

12. The method of claim 11 further comprising packaging the media files with Digital Right Management (DRM) platform.

13. The method of claim 11, wherein encrypting of media files is performed with a standard implementation of the Digital Right Management (DRM) platform.

14. The method of claim 12, wherein decrypting of media files is performed with a limited implementation of the Digital Right Management (DRM) platform.

15. A receiver for presentation and control of computer applications running on a remote host computer, comprising:
data handling means for establishing one or more communication channels between the receiver and the remote host;
data processing means for decoding application output data received from the remote host;
data control means for encoding control signals from the receiver to the remote host; and
input means for entering control commands by a user of the receiver.

16. The receiver of claim 16 capable of automatically obtaining a computer network address.

17. The receiver of claim 16 comprising means for decrypting encrypted application output data received from the remote host.

18. The receiver of claim 16 comprising means for decrypting data packaged with the Digital Rights Management (DRM) platform.
